(19) United States
(12) Patent Application Publication
(10) Pub. No.: US 2020/0122948 A1
(43) Pub. Date: Apr. 23, 2020

(54) DIFFERENCE UNIT

(71) Applicant: HEWLETT-PACKARD DEVELOPMENT COMPANY, L.P., Springg, TX (US)

(72) Inventor: Frank Perdicaro, Corvallis, OR (US)

(21) Appl. No.: 16/605,505

(22) PCT Filed: Mar. 26, 2018
(86) PCT No.: PCT/US2018/024319

§ 371 Date: Oct. 16, 2019

(51) Int. Cl. B65H 23/188; B41J 11/00; B41J 11/46; B41J 15/18

(52) U.S. Cl. CPC B65H 23/1886; B41J 11/0095; B41J 11/46; B65H 2553/40; B41P 2233/50; B65H 2511/512; B41J 15/18

(57) ABSTRACT

A difference unit may include a first sensor to identify a position of a first mark printed on a first web output from a first web press, a second sensor to identify a position of the first mark of the first web, a third sensor to identify a position of a second mark printed on a second web, and a synchronization engine to determine a synchronization difference between the first web and the second web based on the identification of the first mark and second mark as sensed by the second sensor and the third sensor.

### BACKGROUND

An inkjet web press is a high-speed, digital; industrial printing device that prints on a continuous media web at speeds of hundreds of feet per minute. A roll of media such as a paper on an unwinding device supplies the press with a web which is conveyed through the press along a media path. Stationary printheads along the media path may eject droplets of printing fluid onto the web to form images. The web may be conveyed through a drying area and out of the press through rollers to be rewound on a rewinding device.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a difference unit, according to an example of the principles described herein.

FIG. 2 is a block diagram of a system for synchronizing two web presses, according to an example of the principles described herein.

FIG. 3 is a block diagram of a precision repeat device for maintaining a frame-to-frame size consistency along a print media web, according to an example of the principles described herein.

FIG. 4 is a flowchart depicting a method for synchronizing two web presses, according to an example of the principles described herein.

FIG. 5 is a flowchart depicting a method for synchronizing two web presses, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Print fluid used in printing may include a significant amount of water that can saturate the web. The moisture content of the web and tension along the media path within the press, among other factors, may cause the web to expand, lengthening the web. However, when the web is dried, it may shrink back down to a length below its initial state. Therefore, the length of the web coming out of the press may be different than the length of web being fed into the press. This media distortion may complicate post-print finishing operations performed on the printed material by certain finishing devices.

In some examples, two separate presses and associated media webs may be used to form a printed product. A print finishing device may combine multiple print media webs to produce one finished product. The finishing device may fold, cut, or package the multiple print media webs. The methods used to combine these multiple print media webs may use very tight control of the length of each print media web fed into the finishing device. Some print media web presses may not be sufficiently consistent to permit two independent presses printing different content on two separate print media webs to feed the same piece of finishing equipment and maintain synchronization between the two print media webs across tens of thousands of pages or printed frames.

A printing process in a web press may cause distortions in the length of the print media web that complicate post-finishing operations in certain finishing devices, More specifically, the significant application of moisture to the media web during printing, followed by the removal of that moisture through a drying process results in a variability in print frame length and an overall reduction in the length of the web. For example, the media web may shrink at a rate of approximately 0.2%, which is about 1 foot for every 500 feet of media web fed into a press.

Finishing devices that initiate finishing operations on a fixed index basis for each print frame printed on the media web, or, multi-web finishing devices that combine rolls from different sources, do not tolerate such media distortions effectively. This is because the distorted media web eventually causes print frames to drift out of the finishing device's tolerance band, and the finishing operations including folding, combining, and cutting begin to occur within adjacent print frames rather than between print frames as intended. In order to accommodate a higher rate of media distortion associated with a digital inkjet web press, a finishing device initiates finishing operations based on triggers from the media or the press. Advanced digital finishing devices are available that provide such triggering mechanisms based on control systems that compensate for the cumulative error in web length. However, many commercial (and other) print customers who operate digital inkjet web presses prefer the lower costs and higher productivity of fixed index finishing equipment. Moreover, many print customers who already own such legacy finishing equipment want to leverage it forward rather than incur the significant costs associated with acquiring more advanced digital finishing devices.

Some print press systems use methods of dealing with media distortions that are based on dynamically measuring the length of the produced pages and then trying to adjust the frame length to make and keep the length close to its nominal value. However, the mechanisms used to find the length of the page are based on measuring the speed of the media web at a point that is close to the end of the media path of the media web, and measuring the time a page takes to pass through this point. The speed of the media web is not constant, and varies during the time a page takes to pass through the point. There is not a definite speed available to convert time into page length. Determining the precise speed of the media web may be difficult. The speed of the media web may be derived from a number of marks laid on the media web and read by at least one sensor. However, due to considerations such as the real estate constraints of the printed page layout, it is not always possible to have a high enough number of marks on the page to provide an accurate average. The speed can also be measured indirectly, for example, by counting the revolutions of a roll of a known diameter. However, the accuracy of this measurement may suffer from errors due to paper slippage on the roll, or thermally-induced variations of the diameter of the roll. The lack of accuracy in measuring the speed of the media web as it moves through a printing system translates into a lack of accuracy in the measured frame length, which is often outside of acceptable ranges for some printing applications. For example, in packaging and other applications where the frames tend to be long, the errors experienced may not be acceptable.

This issue is compounded when attempting to also synchronize a plurality of media webs printed on two separate web presses in preparation for finishing within the finishing device. A precision repeat (PR) device may be used to correct media distortions within a single printing press, but a PR device is not well calibrated from press-to-press. The result is that a print stream from any one press may be consistent from frame-to-frame, but print streams are not consistent enough from press-to-press to permit use of multi-web finishing systems that are capable of performing finishing operations including folding, combining, and cutting for multiple media webs.

Examples described herein provide a difference unit for synchronizing between two web presses. The difference unit may include a first sensor to identify a position of a first mark printed on a first web output from a first web press, a second sensor to identify a position of the first mark of the first web, a third sensor to identify a position of a second mark printed on a second web, and a synchronization engine to determine a synchronization difference between the first web and the second web based on the identification of the first mark and second mark as sensed by the second sensor and the third sensor.

The difference unit may include a communication engine to send the synchronization difference to the first web press and the second web press. The first and third sensors are located at the same position along a web movement direction.

Examples described herein also provide a system for synchronizing two web presses. The system may include a first web press to output a first web. The first web press includes a first precision repeat device. The system may also include a second web press to output a second web. The second web press may include a second precision repeat device.

The system may also include a difference unit. The difference unit may include a first sensor to identify a position of a first mark printed on the first web, a second sensor to identify position of the first mark of the first web, a third sensor to identify a position of a second mark printed on the second web, and a synchronization engine to determine a synchronization difference between the first web and the second web based on the identification of the first mark and second mark as sensed by the second sensor and the third sensor.

The first precision repeat device of the system may include a first timer to measure a time T1 from a fourth sensor sensing the first mark and a fifth sensor sensing a third mark printed on the first web, and a second timer to measure a time T2 from the fifth sensor sensing the third mark and the fourth sensor sensing a next first mark. The first precision repeat device may also include a first controller to control a gap between the frames by regulating when frames are printed on the web based on T1 and T2.

The second precision repeat device may include a third timer to measure a time T3 from a sixth sensor sensing the second mark and a seventh sensor sensing a fourth mark printed on the second web, and a fourth timer to measure a time T4 from the seventh sensor sensing the fourth mark and the sixth sensor sensing a next second mark. The second precision repeat device may also include a second controller to control a gap between the frames by regulating when the frames are printed on the web based on T3 and T4.

The synchronization engine communicates the synchronization difference to the first controller and the second controller. The first controller and the second controller control their respective gaps based at least partially on the synchronization difference. The system may also include a finishing device downstream from the difference unit to perform at least one post-synchronization operation on the first and second webs.

Examples described herein also provide a method for synchronizing two web presses. The method may include, with a first precision repeat device of a first web press, dynamically adjusting a size of a gap between frames on a first media web, and, with a second precision repeat device of a second web press, dynamically adjusting a size of a gap between frames on a second media web. The method may also include, with a difference engine, identifying, with a first sensor, a position of a first mark printed on the first media web, identifying, with a second sensor, the position of the first mark, and identifying, with a third sensor, the position of a second mark printed on the second media web. The method may further include determining a synchronization difference between the first media web and the second media web based on the identification of the first mark and the second mark as sensed by the second sensor and the third sensor, and sending a synchronization difference to the first web press and the second web press.

In one example, the method may include adjusting a gap between the first web and the second web based on the synchronization difference. Further, the method may include, with a first controller of the first web press and a second controller of the second web press, controlling respective gaps between frames of the first web and the second web, respectively, based at least partially on the synchronization difference.

Determining the synchronization difference between the first web and the second web based on the identification of the first mark and third mark as sensed by the second sensor and the third sensor may include comparing a difference between a time T1 between the first sensor identifying the position of the first mark and the second sensor identifying the position of the first mark, and a time T2 between the second sensor identifying the position of the first mark and the third sensor identifying the position of the third mark. Determining the synchronization difference between the first web and the second web based on the identification of the first mark and third mark as sensed by the second sensor and the third sensor may also include determining if T1 does not equal T2. When T1 is greater than T2, decreasing the gap between printed frames of the first web and printed frames of the second web. When T2 is greater than T1, increasing the gap between the printed frames of the first web and the printed frames of the second web.

Dynamically adjusting the size of the gap between frames on the first media web with the first precision repeat device of the first web press may include measuring a third time T3 between a fourth sensor sensing the first mark printed on the first web and a fifth sensor sensing the second mark printed on the first web, measuring a fourth time T4 between the fifth sensor sensing the second mark and the fourth sensor sensing a next first mark, and adjusting a gap between printed frames when T3 does not equal T4. Dynamically adjusting the size of the gap between frames on the second media web, with the second precision repeat device of the second web press, may include measuring a fifth time T5 between a sixth sensor sensing the third mark printed on the second web and a seventh sensor sensing a fourth mark printed on the second web, measuring a sixth time T6 between the sixth sensor sensing the third mark and the seventh sensor sensing a next third mark, and adjusting a gap between printed frames when T5 does not equal T6. The method may also include decreasing the gap between printed frames by reducing an amount of time between printing sequential frames on a media web, and increasing the gap between printed frames by increasing the amount of time between printing sequential frames on a media web. Adjusting a gap between printed frames comprises determining an error in timing between sensing the first and second marks, the error according to the following equation:

error=sign(T1−T2)*min(T1,T2) Eq. 1

where: sign(x) is 1 if x>0, −1 if x<0, and zero if x=0, and minx, y) is the minimum of x and y.

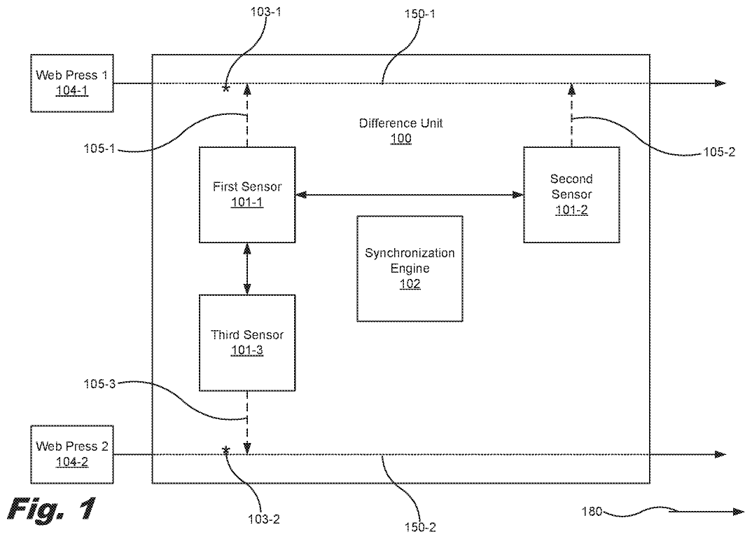

Turning now to the figures, FIG. 1 is a block diagram of a difference unit (100), according to an example of the principles described herein. The difference unit (100) synchronizes two web presses and their respective print media webs, and may include a first sensor (101-1) to identify a position of a first mark (103-1) printed on a first web (150-1) output from a first web press (104-1). A second sensor (101-2) may be included in the difference unit (100) to identify a position of the first mark (103-1) of the first web (150-1). The second sensor (101-2) may be located further downstream relative to a direction of travel of the first web (150-1) as indicated by arrow (180). the sensors (101) described throughout this disclosure may include a scanner, a camera, or other imager, implementing various image sensors such as, for example, charge coupled devices (CODs) or complementary metal-oxide-semiconductor (CMOS) devices.

The difference unit (100) may also include a third sensor (101-3) to identify a position of a second mark (103-2) printed on a second web (150-1). A synchronization engine (102) may be included in the difference unit (100) to determine a synchronization difference between the first web (150-1) and the second web (150-2) based on the identification of the first mark (103-1) and second mark (103-2) as sensed by the second sensor (101-2) and the third sensor (101-3).

The marks (103-1, 103-2, collectively referred to herein as 103) may be, for example top-of-form (TOF) marks that are printed by the first web press (104-1) and the second web press (104-2) onto the first web (150-1) and second web (150-2), respectively. The marks (103) may take any form that the sensors (101-1, 101-2, 101-3, collectively referred to herein as 101) can detect.

The sensors (101) may be any optical sensing device that can detect the marks (103) printed on the first web (150-1) and second web (150-2). The three sensors (101) are mounted rigidly within the difference unit (100) in a right triangle with each of the sensors (101) being located at one of the three vertices of the right triangle. The first sensor (101-1) and the second sensor (101-2) image the first web (150-1), and the third sensor (101-3) images the second web (150-2), Each sensor (101) includes a detection path (105-1, 105-2, 105-3, collectively referred to herein as 105) which is a point at which the sensors (101) detect the surface of the media webs (150).

The synchronization engine (102) may receive as input data from each of the sensors (101), and acts as a timing circuit that detects the timing between the first web (150-1) and the second web (150-2) based on the sensors (101) detecting the marks (103) on the first web (150-1) and the second web (150-2). Specifically, the first sensor (101-1) may sense the first mark (103-1) as it passes the first sensor (101-1), and the second sensor (101-2) may sense the first mark (103-1) as it passes the second sensor (101-2). A time between the first sensor (101-1) sensing the first mark (103-1) and the second sensor (101-2) sensing the first mark (103-1) may be determined and indicates the speed at which the first web (150-1) is moving and a frame-to-frame variation along the first web (150-1).

The third sensor (101-3) detects the second mark (103-2) printed on the second web (150-2). The objective is to ensure that the first mark (103-1) crosses the detection path (105-2) of the second sensor (101-2) at the same time the second mark (103-2) crosses the detection path (105-3) of the third sensor (101-3). The layout of the sensors (101) in a right triangle assures that the time between the second mark (103-2) crossing the detection path (105-2) of the second sensor (101-2) and the time the second mark (103-2) crosses the detection path (105-3) of the third sensor (101-3) is positive and non-zero. There is no ability to measure negative time, and like all other real devices, the synchronization engine (102) of the difference unit (100) measures positive time. The fixed distance between the second sensor (101-2) and the first sensor (101-1) may be subtracted from the reading of the time between the second sensor (101-2) and the third sensor (101-3) to provide a synchronization difference. The synchronization difference is to be centered around a constant such as, for example, zero. The synchronization difference may then be used to correct the difference between the alignment of the first mark (103-1) and the second mark (103-2) so that the first web (150-1) is synchronized with the second web (150-1) and their respective printed frames are aligned with one another.

In one example, the variance from the constant (i.e., the synchronization difference) may be divided in half with each half serving as a correction that can be supplied to the two web presses (104-1, 104-2, collectively referred to herein as 104) so that both web presses (104) are adjusted to bring the synchronization difference back to the constant and maintain the synchronization difference at the constant or at least within a threshold. Thus, where the difference value is positive, the first web (105-1) leads the second web (150-2), and, thus, the first web (150-1) may slow down and the second web (150-2) may speed up. In other words, frames from the first web (105-1) happen sooner in the print stream, so the frames will be shorter. Where the difference is negative the inverse occurs. When there is no difference, no correction is applied. Likewise, the frames on the second web (150-2) will be longer. Shortening and lengthening the frames may be performed by the web presses (104) during printing, and any changes made by the web presses (104) are detected at the difference engine (100). In this manner, the web presses (104) and the difference engine (100) form a feedback loop. The feedback from the difference unit (100) may be provided to the web presses (104) often to ensure that the synchronization difference is continually corrected.

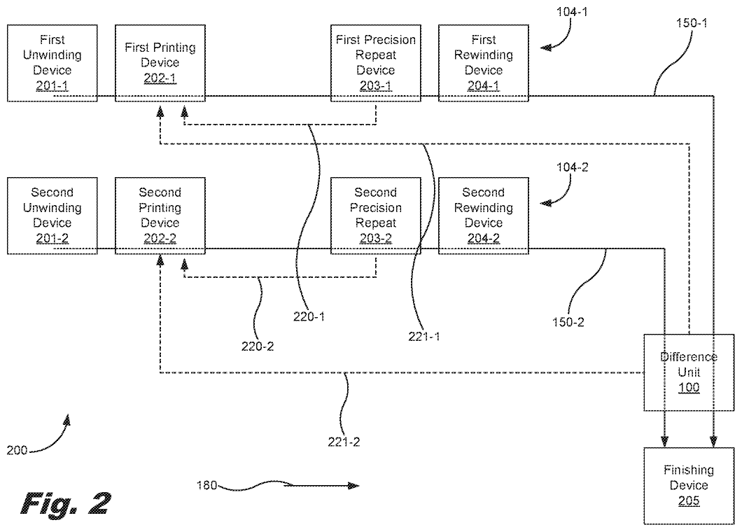

FIG. 2 is a block diagram of a system (200) for synchronizing two web presses (104), according to an example of the principles described herein. The system includes the first web press (104-1) to output a first web (150-1). The first web press (104-1) includes a first precision repeat device (203-1). A second web press (104-2) is also included in the system (200) to output a second web (150-2). The second web press (104-2) includes a second precision repeat device (203-2).

Further, located downstream, the difference unit (100) of FIG. 1 is included. The difference unit (100) includes the first sensor (101-1), the second sensor (101-2) the third sensor (101-3), and the synchronization engine (102) as described herein in connection with FIG. 1.

Each of the web presses (104) may include an unwinding device (201-1, 201-2, collectively referred to herein as 201). The unwinding device includes a spool of print media web that serves as the first web (150-1) and the second web (150-2). Further, each web press (104) may each include a number of printing devices (202-1, 202-2, collectively referred to herein as 202) that print images onto the first web (150-1) and the second web (150-2), respectively.

Each web press (104) may also include a rewinding device (204-1, 204-2, collectively referred to herein as 204). The rewinding device (204) is used to collect the printed-on web (150) onto a spool much like the web (150) existed as it sat on the unwinding device (201) before the web (150) was unspooled from the unwinding device (201). However, because the first web (150-1) and the second web (150-2) are fed into the difference unit as depicted in FIGS. 1 and 2, the rewinding devices (204) may be bypassed.

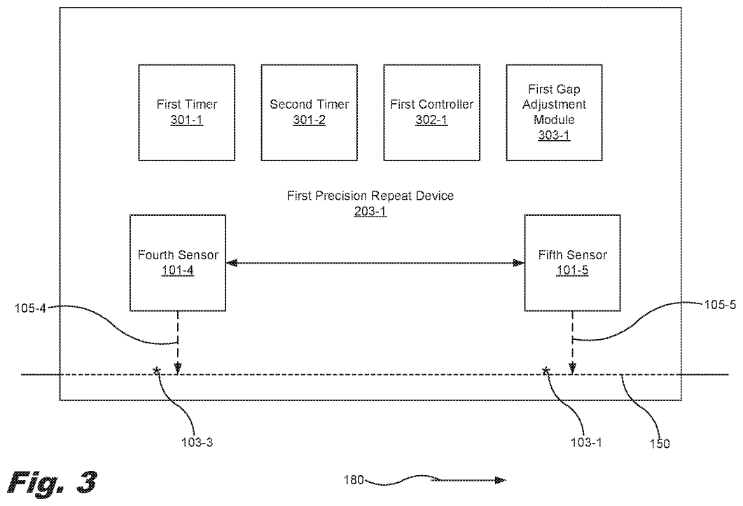

The precision repeat devices (203) are, like the difference unit (100), feedback devices that provide feedback to the printing devices (202), but within their respective web presses (104). FIG. 3 is a block diagram of a precision repeat device (203) for maintaining a frame-to-frame size consistency along a print media web, according to another example of the principles described herein.

The first precision repeat device (203-1) may include a first timer (301-1) to measure a time T1 from a fourth sensor (101-4) sensing the first mark (103-1) and a fifth sensor (101-5) sensing a third mark (103-3) printed on the first web (150-1). A second timer (301-2) may be included to measure a time T2 from the fifth sensor (101-5) sensing the third mark (103-3) and the fourth sensor (101-4) sensing a next first mark (103-1) located on a next printed frame. A first controller (302-1) may be included in the first precision repeat device (203-1) to control a gap between the frames by regulating when frames are printed on the first web (150-1) based on T1 and T2. The second precision repeat device (203-2) includes identical elements as described in connection with the first precision repeat device (203-1) and are described here without depiction in the figures to avoid repetition. The second precision repeat device (203-2) includes a third timer (301-3) to measure a time T3 from a sixth sensor (101-6) sensing the second mark (103-2) and a seventh sensor (101-7) sensing a fourth mark (103-4) printed on the second web (150-2). The second precision repeat device (203-2) also includes a fourth timer (301-4) to measure a time T4 from the seventh sensor (101-7) sensing the fourth mark (103-4) and the sixth sensor (101-6) sensing a next second mark (101-2) printed on the second web (150-2). A second controller (302-2) is also included in the second precision repeat device (203-2) to control a gap between the frames by regulating when the frames are printed on the second web (150-2) based on T3 and T4.

With description now from FIG. 3, the first timer (301-1) measures the time between these sensing events as time T1. That is, the first timer (301-1) starts counting when the fourth sensor (101-4) senses the first mark (103-1) in a subsequent frame (i.e., frame n+1), and stops counting when the fifth sensor (101-5) senses the third mark (103-3) in the first frame (i.e., frame n). Likewise, the second timer (301-2) measures the time between the fifth sensor (101-5) sensing the third mark (103-3) in frame n, and the fourth sensor (101-4) sensing a next first mark (103-1) in the subsequent frame n+1. The second timer (301-2) measures the time between these sensing events as time T2.

The first controller (302-1), executing a frame first gap adjustment module (303-1), receives and analyzes times T1 and T2 to determine if there is a difference between times T1 and T2. A difference between times T1 and T2 indicates that the distance between the first mark (103-1) and the third mark (103-3) is not the same as the fixed distance between fourth sensor (101-4) and the fifth sensor (101-5), which in turn indicates that there is some error, or distortion, in the length of the frames. More specifically, when T1 is less than T2, the first controller (302-1) determines that the frame length has undergone shrinkage, and that the gap should be therefore be increased in size to compensate for the shrinkage. The error, or amount of time by which the gap is adjusted is the lesser of the two times T1 and T2. The analysis performed by execution of the first gap adjustment module (303-1) to determine the correction error is demonstrated by the following equation:

error=sign(T1−T2)*min(T1,T2) Eq. 1

where: sign(x) is 1 if x>0, −1 if x<0, and zero if x=0, and min(x, y) is the minimum of x and y.

In a second scenario where the first web (150-1) has undergone expansion, the fifth sensor (101-5) senses the third mark (103-3) in frame n as the first web (150-1) travels along the print path in the direction indication by arrow (180). Shortly thereafter, the fourth sensor (101-4) sees the first mark (103-1) in frame n+1, The second timer (301-2) measures the time between these sensing events as time T2. That is, the second timer (301-2) starts counting when fifth sensor (101-5) senses the third mark (103-3) in frame n, and it stops counting when the fourth sensor (101-4) senses the first mark (103-1) in frame n+1. Likewise, the first timer (301-1) measures the time between sensor the fourth sensor (150-1) sensing the first mark (103-1) in frame n+1, and the fifth sensor (101-5) sensing the third mark (103-3) in frame n+1. The first timer (301-1) measures the time between these sensing events as time T1.

The first controller (302-1) receives and analyzes times T1 and T2 for a difference. Again, a difference between times T1 and T2 indicates that the distance between the first mark (103-1) and the third mark (103-3) is not the same as the fixed distance between the fourth sensor (101-4) and the fifth sensor (101-5), which in turn indicates that there is some error, or distortion, in the length of the frames. More specifically, when T1 is greater than T2, the first controller (302-1) determines that the frame length has undergone expansion, and that the gap should therefore be decreased in size to compensate for the expansion. The error, or amount of time by which the gap is adjusted is the lesser of the two times T1 and T2, As in the above example, the analysis performed by execution of the first gap adjustment module (303-1) to determine the correction error is demonstrated by Eq. 1 above.

Dynamically adjusting the size of the gap between frames on the first media web (150-1) with the first precision repeat device (203-1) of the first web press (104-1) may include measuring a third time T3 between a fourth sensor (101-4) sensing the first mark (103-1) printed on the first web (150-1) and a fifth sensor (101-5) sensing the second mark (103-2) printed on the first web (150-1), measuring a fourth time T4 between the fifth sensor (101-5) sensing the second mark (103-2) and the fourth sensor (101-4) sensing a next first mark (103-1), and adjusting a gap between printed frames when T3 does not equal T4. Dynamically adjusting the size of the gap between frames on the second media web (150-2), with the second precision repeat device (203-1) of the second web press (104-2), may include measuring a fifth time T5 between a sixth sensor (101-6) sensing the third mark (103-3) printed on the second web (150-2) and a seventh sensor (101-7) sensing a fourth mark (103-4) printed on the second web (150-2), measuring a sixth time T6 between the sixth sensor (101-6) sensing the third mark (103-3) and the seventh sensor (101-7) sensing a next third mark (103-3), and adjusting a gap between printed frames when T5 does not equal T6. The method may also include decreasing the gap between printed frames by reducing an amount of time between printing sequential frames on a media web (150), and increasing the gap between printed frames by increasing the amount of time between printing sequential frames on a media web (150).

With reference to FIG. 3, FIG. 2 depicts the manner in which the data created by the first precision repeat device (203-1) and the second precision repeat device (203-2) are used to alter the manner in which frames are printed on the first web (150-1) and the second web (150-2). The first controller (302-1) of the first precision repeat device (203-1) and the second controller (302-2) of the second precision repeat device (203-2) send instructions to the first printing device (202-1) and second printing device (202-2), respectively to adjust gaps between printed frames of print media webs (150) as indicated by arrows (220-1, 220-2). In this manner, the first precision repeat device (203-1) and the second precision repeat device (203-2) serve to reduce or eliminate frame-to-frame variance.

In addition to the feedback provided by the first precision repeat device (203-1) and the second precision repeat device (203-2), the difference unit (100) also provides feedback. As described herein, the synchronization difference determined by the difference unit (100) is provided to the first printing device (202-1) and second printing device (202-2), respectively, via communication lines (221-1, 221-2). In one example, the difference unit (100) divides the variance into two separate halves such that a signal going to the first printing device (202-1) may include correction information instructing the first printing device (202-1) to correct its speed in a first direction (faster or slower), and the signal going to the second printing device (202-2) may include correction information instructing the second printing device (202-2) to correct its speed in a second direction (slower or faster) opposite to the direction of correction by the first printing device (202-1). In this manner, rather than a single one of the first printing device (202-1) and second printing device (202-2) making the correction, both printing devices (202-1, 202-2) participate in correcting the variance. In this manner, the difference unit (100) serves to reduce or eliminate stream-to-stream variance between two webs (150).

In one example, the synchronization difference may be communicated by the synchronization engine (102) to the first controller (302-1) of the first precision repeat device (203-1) and the second controller (302-2) of the second precision repeat device (203-2). In this example, the first controller (302-1) and the second controller (302-2) may act as passive intermediary devices that forwards the data representing the synchronization difference onto the first printing device (202-1) and the second printing device (202-2), or the first controller (302-1) and the second controller (302-2) may further process the data representing the synchronization difference. For example, the first controller (302-1) and the second controller (302-2) control their respective gaps based at least partially on the synchronization difference. In other words, the variance in gaps between printed frames controlled by the precision repeat devices (203-1, 203-2) may also include instructions to synchronize the two print media webs (150) using the data representing the synchronization difference. In this example, the combination of data defining corrections to the variance in the gaps and the data representing the synchronization difference may be sent to the first printing device (202-1) and the second printing device (202-2) for use in correcting these issues. Thus, in some examples, stream-to-stream variation correction may be added on top of existing precision repeat device (203) frame-to-frame variance so that that composite produces both consistent frame sizes and consistent, synchronized streams.

In another example, the data representing the synchronization difference may be sent directly to the first printing device (202-1) and the second printing device (202-2) separate from the data defining corrections to the variance in the gaps produced by the precision repeat devices (203-1, 203-2). Further, the small size of the signals and the distance between the precision repeat devices (203-1, 203-1) and printing devices (202-1, 202-2) of each web press (104-1, 104-2), and the difference engine (100) which is mounted relatively closer to the finishing device (205) may affect the transmission of the data representing the synchronization difference. Thus, the data representing the synchronization difference communicated to each press via communication lines (221-1, 221-2) may not be applied all at once. Instead, in one example, the data representing the synchronization difference may be fed into the web presses (104) of the system (200) through a filter. In this example, the data representing the synchronization difference may be sent via a TOF windowing signal.

In one example, the time-of-flight transit from the first sensor (101-1) to the second sensor (101-2) as depicted in FIG. 1 may be used to calibrate the distance between the first sensor (101-1) and the second sensor (101-2). Such a calibration may occur once in the lifetime of the difference unit (101) or may be perform any number of times before, during, and after operation of the difference unit (100). Further, in one example, signals generated by the first sensor (101-1) and the second sensor (101-2) may be used as a heartbeat signal; a periodic signal generated by the first sensor (101-1) and the second sensor (101-2) and associated synchronization engine (104-2) to indicate operation or to synchronize other parts of the difference unit (101).

Returning again to FIG. 2, the we press synchronization system (200) may include a finishing device (205) downstream from the difference unit (100) to perform at least one post-synchronization operation on the first web (150-1) and the second web (150-2). In one example, the finishing device (205) may combine the two streams of webs (150) into a common stack, and perform a number of finishing processes including cutting, folding, collating, packaging, other finishing processes, or combinations thereof.

Thus, the system (200) includes two web presses (104-1, 104-2) that run their outputs together. Each web press (104) includes a precision repeat device (203-1, 203-2) that provides feedback to cause the web presses (104) to print; on average, pages of a fixed size regardless of changes in the size of the webs (150-1, 150-2) due to moisture content, tension along the media path of the webs, etc., as printing is performed. The difference unit (100) detects differences in frame size between the webs (150), and acts to correct the size differences by operating the precision repeat devices (203) on each web press (104-1, 104-2). Each web press (104) is fed back half of the overall error from the difference unit (100), with an inverted sign. The media web (150) which is too short is directed to become longer and the media web (150) which is too long is directed to become shorter.

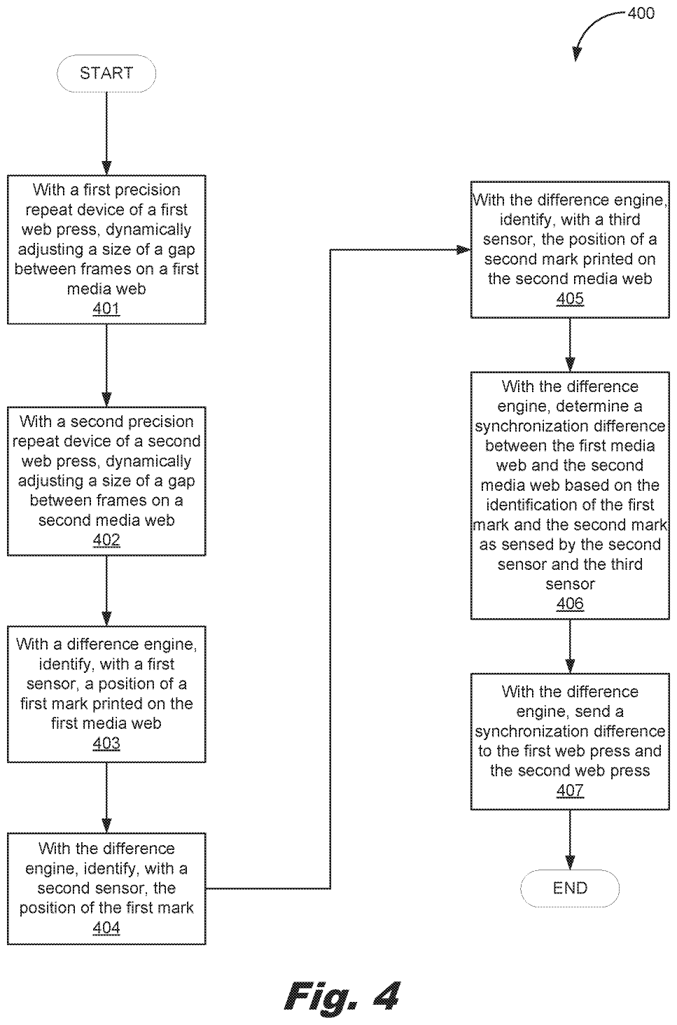

FIG. 4 is a flowchart (400) depicting a method for synchronizing two web presses (104-1, 104-2), according to an example of the principles described herein. The method (400) may include, with a first precision repeat device (203-1) of a first web press (104-1), dynamically adjusting (block 401) a size of a gap between frames on a first media web (150-1). The method (400) may further include, with a second precision repeat device (203-2) of a second web press (104-2), dynamically adjusting (block 402) a size of a gap between frames on a second media web (150-2).

A difference engine (100) may be used to identify (block 403), with a first sensor (101-1), a position of a first mark (103-1) printed on the first media web (150-1). The method (400) may further include, with the difference engine (100), identifying (block 404), with a second sensor (101-2), the position of the first mark (103-1) and identifying (block 405), with a third sensor (101-3), the position of a second mark (103-2) printed on the second media web (150-2).

The synchronization engine (102) of the difference engine (101) may be used to determine (block 406) a synchronization difference between the first media web (150-1) and the second media web (150-2) based on the identification of the first mark (103-1) and the second mark (103-2) as sensed by the second sensor (101-2) and the third sensor (101-3). A synchronization difference may be sent (block 407) to the first web press (104-1) and the second web press (104-2) using the synchronization engine (102) of the difference engine (101).

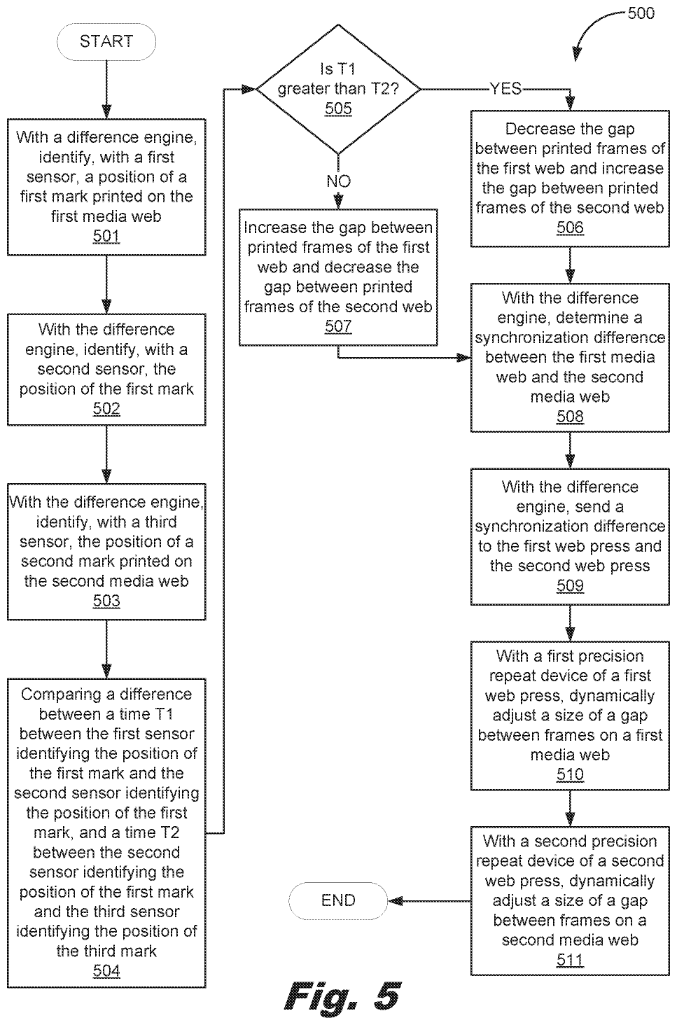

FIG. 5 is a flowchart depicting a method (500) for synchronizing two web presses (104-1, 104-2), according to another example of the principles described herein. The method (500) may include, with a difference engine (100), identifying (block 501), with a first sensor (101-1), a position of a first mark (103-1) printed on the first media web (150-1). The method (500) may further include, with the difference engine (100), identifying (block 502), with a second sensor (101-2), the position of the first mark (103-1) and identifying (block 405), with a third sensor (101-3), the position of a second mark (103-2) printed on the second media web (150-2). The method (500) may further include, with the difference engine (100), identifying (block 503), with a third sensor (101-3), the position of a second mark (103-2) printed on the second media web (150-2).

The difference between a time T1 between the first sensor (101-1) identifying the position of the first mark (103-1) and the second sensor (101-2) identifying the position of the first mark (101-1), and a time T2 between the second sensor (101-2) identifying the position of the first mark (103-1) and the third sensor (101-3) identifying the position of the third mark (103-3) may be compared (block 504), and a determination (Block 505) may be made as to whether T1 is greater than T2. If T1 is greater than T2 (Block 505, determination YES), then the first precision repeat device (203-1) and the second precision repeat device (203-2) may decrease (block 506) the gap between printed frames of the first web (150-1) and the second web (150-2), respectively. If, however, T1 is not greater than T2 (i.e., T1 is less than T2) (Block 505, determination NO), then the first precision repeat device (203-1) and the second precision repeat device (203-2) may increase (block 507) the gap between printed frames of the first web (150-1) and the second web (150-2), respectively.

Blocks 506 and 507 move to block 508, where, a synchronization difference between the first media web (150-1) and the second media web (150-2) may be determined (block 508) using the difference engine (100). The method (500) may also include, with the difference engine (100), sending (block 509) a synchronization difference to the first web press (104-1) and the second web press (104-2). The method (500) may include, with a first precision repeat device (203-1) of a first web press (104-1), dynamically adjusting (lock 510) a size of a gap between frames on a first media web (150-1). Further, the method (500) may include, with a second precision repeat device (203-2) of a second web press (104-2), dynamically adjusting (block 511) a size of a gap between frames on a second media web (150-2).

The present examples may be implemented, at least partially, as a computer program product stored on the precision repeat devices (203) and the difference engine (100), and may include a computer readable storage medium comprising computer usable program code embodied therewith. The computer usable program code, when executed by a processor, may execute the processes described herein including the methods of FIGS. 4 and 5.

The specification and figures describe a difference unit for synchronizing between two web presses. The difference unit may include a first sensor to identify a position of a first mark printed on a first web output from a first web press, a second sensor to identify a position of the first mark of the first web, a third sensor to identify a position of a second mark printed on a second web, and a synchronization engine to determine a synchronization difference between the first web and the second web based on the identification of the first mark and second mark as sensed by the second sensor and the third sensor.

This difference unit and associated systems and methods permit the synchronization of two print streams. Because the correction is split between two presses, distortion of each print stream is minimized. For very large print jobs, two print streams may be run in parallel, effectively doubling the print speed compared to a single press system. Further, the difference unit may be implemented in legacy printing presses resulting, making sales of multiple-press systems with the difference unit less difficult.

The preceding description has been presented to illustrate and describe examples of the principles described. This description is not intended to be exhaustive or to limit these principles to any precise form disclosed. Many modifications and variations are possible in light of the above teaching.

What is claimed is:

1. A difference unit for synchronizing between two web presses, comprising:
a first sensor to identify a position of a first mark printed on a first web output from a first web press;
a second sensor to identify a position of the first mark of the first web;
a third sensor to identify a position of a second mark printed on a second web; and
a synchronization engine to determine a synchronization difference between the first web and the second web based on the identification of the first mark and second mark as sensed by the second sensor and the third sensor.

2. The difference unit of claim 1, comprising a communication engine to send the synchronization difference to the first web press and the second web press.

3. The difference unit of claim 1, wherein the first and third sensors are located at the same position along a web movement direction.

4. A system for synchronizing two web presses, comprising:
a first web press to output a first web, the first web press comprising a first precision repeat device;
a second web press to output a second web; the second web press comprising a second precision repeat device; and
a difference unit comprising:
a first sensor to identify a position of a first mark printed on the first web;
a second sensor to identify position of the first mark of the first web;
a third sensor to identify a position of a second mark printed on the second web; and
a synchronization engine to determine a synchronization difference between the first web and the second web based on the identification of the first mark and second mark as sensed by the second sensor and the third sensor.

5. The system of claim 4, wherein:
the first precision repeat device comprises:
a first timer to measure a time T1 from a fourth sensor sensing the first mark and a fifth sensor sensing a third mark printed on the first web;
a second timer to measure a time T2 from the fifth sensor sensing the third mark and the fourth sensor sensing a next first mark; and
a first controller to control a gap between the frames by regulating when frames are printed on the web based on T1 and T2; and
the second precision repeat device comprises:
a third timer to measure a time T3 from a sixth sensor sensing the second mark and a seventh sensor sensing a fourth mark printed on the second web;
a fourth timer to measure a time T4 from the seventh sensor sensing the fourth mark and the sixth sensor sensing a next second mark; and
a second controller to control a gap between the frames by regulating when the frames are printed on the web based on T3 and T4.

6. The system of claim 5, wherein:
the synchronization engine communicates the synchronization difference to the first controller and the second controller; and
the first controller and the second controller control their respective gaps based at least partially on the synchronization difference.

7. The system of claim 4, comprising a finishing device downstream from the difference unit to perform at least one post-synchronization operation on the first and second webs.

8. A method for synchronizing two web presses, comprising:
with a first precision repeat device of a first web press, dynamically adjusting a size of a gap between frames on a first media web;
with a second precision repeat device of a second web press, dynamically adjusting a size of a gap between frames on a second media web;
with a difference engine:
identifying, with a first sensor, a position of a first mark printed on the first media web;
identifying, with a second sensor, the position of the first mark;
identifying, with a third sensor, the position of a second mark printed on the second media web;
determining a synchronization difference between the first media web and the second media web based on the identification of the first mark and the second mark as sensed by the second sensor and the third sensor; and
sending a synchronization difference to the first web press and the second web press.

9. The method of claim 8, comprising adjusting a gap between the first web and the second web based on the synchronization difference.

10. The method of claim 9, comprising with a first controller of the first web press and a second controller of the second web press, controlling respective gaps between frames of the first web and the second web, respectively, based at least partially on the synchronization difference.

11. The method of claim 8, wherein determining the synchronization difference between the first web and the second web based on the identification of the first mark and third mark as sensed by the second sensor and the third sensor comprises:
comparing a difference between:
a time T1 between the first sensor identifying the position of the first mark and the second sensor identifying the position of the first mark; and
a time T2 between the second sensor identifying the position of the first mark and the third sensor identifying the position of the third mark; and
determining if T1 does not equal T2.

12. The method of claim 11, wherein:
when T1 is greater than T2, decreasing the gap between printed frames of the first web and printed frames of the second web; and
when T2 is greater than T1, increasing the gap between the printed frames of the first web and the printed frames of the second web.

13. The method of claim 8, wherein, with the first precision repeat device of the first web press, dynamically adjusting the size of the gap between frames on the first media web comprises:
measuring a third time T3 between a fourth sensor sensing the first mark printed on the first web and a fifth sensor sensing the second mark printed on the first web;
measuring a fourth time T4 between the fifth sensor sensing the second mark and the fourth sensor sensing a next first mark; and
adjusting a gap between printed frames when T3 does not equal T4.

14. The method of claim 8, wherein, with the second precision repeat device of the second web press, dynamically adjusting the size of the gap between frames on the second media web comprises:
measuring a fifth time T5 between a sixth sensor sensing the third mark printed on the second web and a seventh sensor sensing a fourth mark printed on the second web;
measuring a sixth time T6 between the sixth sensor sensing the third mark and the seventh sensor sensing a next third mark; and
adjusting a gap between printed frames when T5 does not equal T6.

15. The method of claim 12, wherein
decreasing the gap between printed frames comprises reducing an amount of time between printing sequential frames on a media web; and
increasing the gap between printed frames comprises increasing the amount of time between printing sequential frames on a media web;
wherein adjusting a gap between printed frames comprises determining an error in timing between sensing the first and second marks.
